(19) United States
(12) Patent Application Publication
(10) Pub. No.: US 2012/0326535 A1
(43) Pub. Date: Dec. 27, 2012

(54) ELECTROMOTIVE INDUCTIVE CORE FOR A GENERATOR

(76) Inventor: Jung-Tang Lin, Taichung City (TW)

(21) Appl. No.: 13/169,012

(22) Filed: Jun. 26, 2011

(51) Int. Cl. H02K 7/065; H02K 53/00

(52) U.S. Cl. 310/24; 74/DIG. 9

(57) ABSTRACT

An electromotive inductive core for a generator has a first rotation disk and at least two second rotation disks. A driving shaft passes through a central position of the first and second rotation disks and is connected to a power unit to drive the first and second rotation disks to simultaneously rotate. A plurality of permanent magnets and auxiliary magnets are disposed around each of the first and second rotation disks, and the permanent magnets and the auxiliary magnets are disposed on respective disks in an alternating manner and interleaved between adjacent disks with opposite poles facing each other. Furthermore, a plurality of sleeve tubes are disposed adjacent to at least a side of each of the first rotation disk and the second rotation disk, each sleeve tube having a slidable force magnet and wrapped with a coil, with ends of each coil electrically connected to a battery.

### BACKGROUND OF THE INVENTION

1. Field of the Invention

The present invention relates to an electromotive inductive core for a generator, and more particularly to an electromotive inductive core having a plurality of coils.

2. Description of the Related Art

Typical power generators utilize the principle of electromotive induction to transform kinetic energy into electrical energy. There are various kinetic energy sources, such as wind power, water power directly pushing turbines coupled to a generator, or thermal energy heating water to generate steam to push turbines coupled to a generator. Regardless of the type of kinetic energy source, the shafts of the turbines connected to the generator rotate a coil, such that the coils and the magnetic field have relative movements which generate current.

However, most typical generators only have one set of coils which can only provide very limited power. Furthermore, with limited output power, the electricity cannot feed back to the generator itself; therefore, the generator still relies on kinetic energy for operation. Consequently, the efficiency and operational costs of this generating procedure are easily affected by external factors such as dry seasons, or energy price hikes.

Therefore, it is desirable to provide an electromotive inductive core for a generator to mitigate and/or obviate the aforementioned problems.

### SUMMARY OF THE INVENTION

An objective of the present invention is to provide an electromotive inductive core for a generator.

In order to achieve the above-mentioned objectives, an electromotive inductive core for a generator has a first rotation disk and at least two second rotation disks. The first rotation disk is sandwiched with a respective distance between the two second rotation disks. A driving shaft passes through a central position of the first and second rotation disks and is connected to a power unit to drive the first and second rotation disks to simultaneously rotate. A plurality of permanent magnets and auxiliary magnets are disposed around each of the first and second rotation disks adjacent to an outer edge thereof, and the permanent magnets and the auxiliary magnets are disposed on respective disks in an alternating manner and interleaved between adjacent disks with opposite poles facing each other. Furthermore, a plurality of sleeve tubes are disposed adjacent to at least a side of each of the first rotation disk and the second rotation disk, each sleeve tube having a slidable force magnet and wrapped with a coil. Ends of each coil are electrically connected to a battery.

The above-mentioned electromotive inductive core has following benefits: 1. the electromotive inductive core has more than one sleeve tube, and each sleeve tube is wrapped with the coil and has a slidable force magnet such that each coil and force magnet are paired to work with each other. 2. The electricity output by the electromotive inductive core is direct current, but with an alternating and direct electric power switching device, it can be converted for application with: automobile use, household use, industrial use, or auxiliary electricity generating systems for energy conservation purposes.

Other objects, advantages, and novel features of the invention will become more apparent from the following detailed description when taken in conjunction with the accompanying drawings.

### BRIEF DESCRIPTION OF THE DRAWINGS

FIG. 1 is a perspective assembly view of an embodiment of the present invention.

FIG. 2 is a perspective exploded drawing of an embodiment of the present invention.

FIG. 3 is a cross-sectional view of an embodiment of the present invention during a power generating process.

FIG. 4 is a schematic view of movements of the force magnets according to an embodiment of the present invention during a power generating process.

FIG. 5 is another schematic drawing of movements of the force magnets according to an embodiment of the present invention during a power generating process.

FIG. 6 shows another embodiment of the present invention.

### DETAILED DESCRIPTION OF THE PREFERRED EMBODIMENT

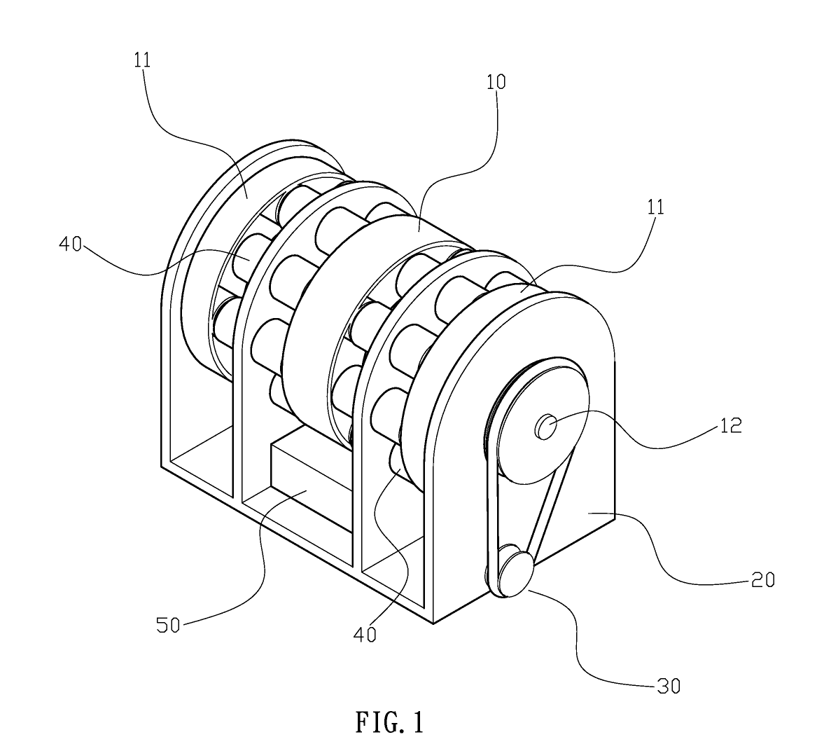

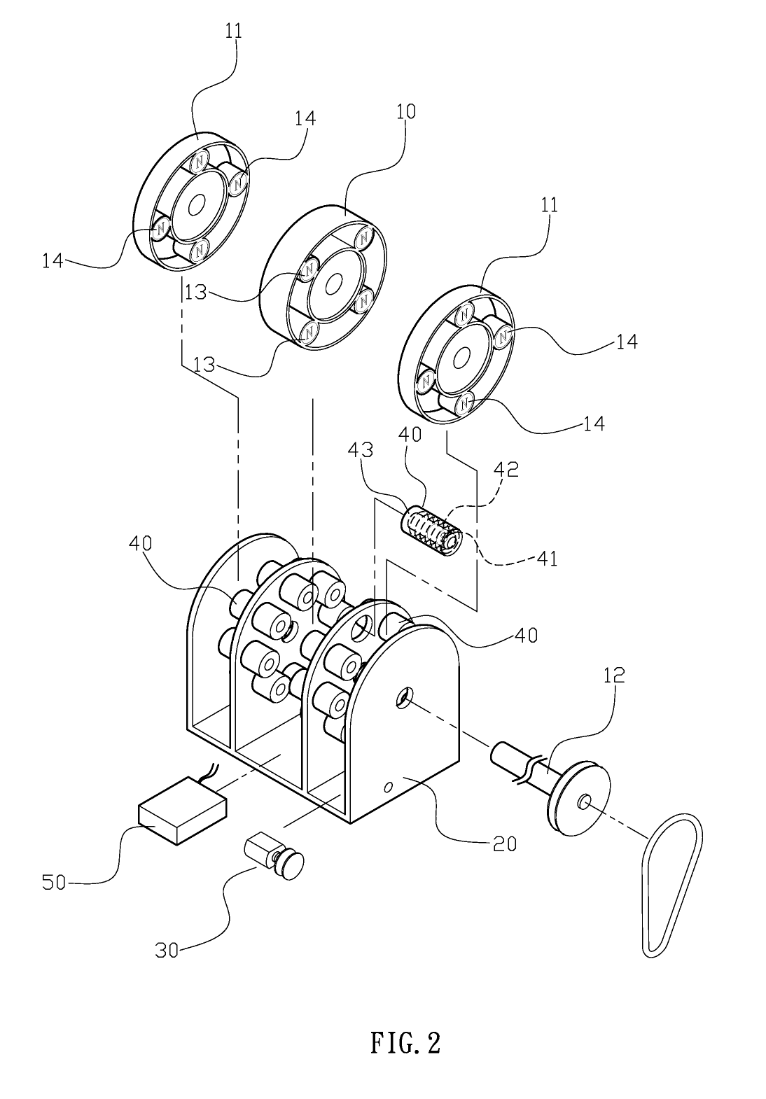

Please refer to FIG. 1 and FIG. 2. An electromotive inductive core for a generator has a first rotation disk 10 and at least two second rotation disks 11. The first rotation disk 10 is sandwiched with a respective distance between each of the two second rotation disks 11. A driving shaft 12 passes through a central position of the first and second rotation disks and is pivoted onto a supporting frame 20 and connected to a power unit 30 to drive the first and second rotation disks 10, 11 to simultaneously rotate. A plurality of permanent magnets 13 and auxiliary magnets 14 are disposed around each of the first and second rotation disks 10, 11, respectively, adjacent to an outer edge thereof, and the permanent magnets 13 and the auxiliary magnets 14 are disposed on respective disks in an alternating manner and interleaved between adjacent disks with opposite poles facing each other. Furthermore, a plurality of sleeve tubes 40 are disposed on the supporting frame 20 and adjacent to at least a side of each of the first rotation disk and the second rotation disk 10, 11. Each sleeve tube 40 has a slidable force magnet 41 and is wrapped with a coil 42, with ends of each coil 42 electrically connected to a battery 50. Furthermore, the battery 50 is electrically connected to the power unit 30.

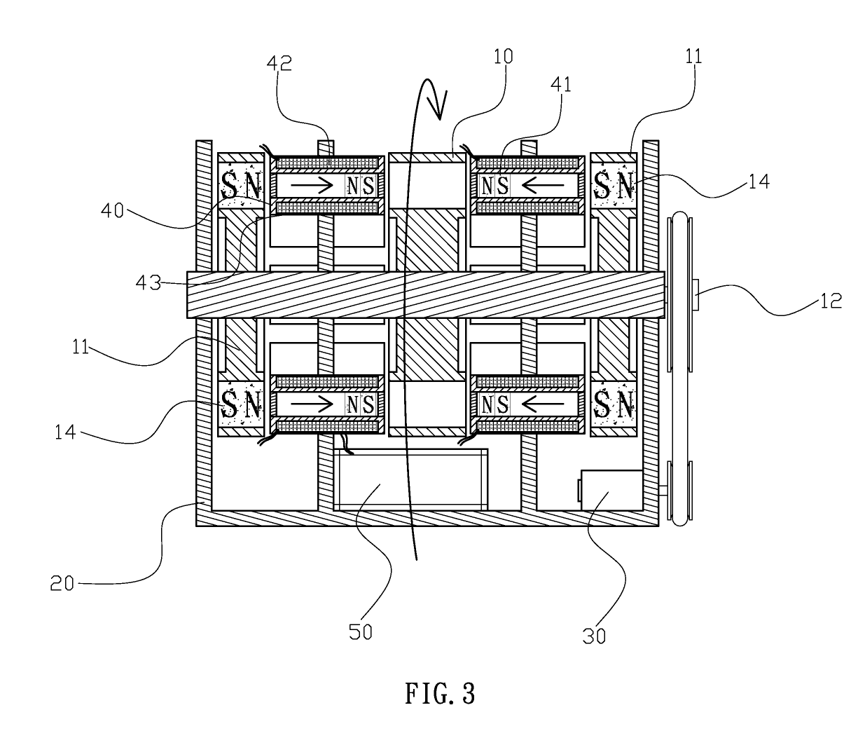

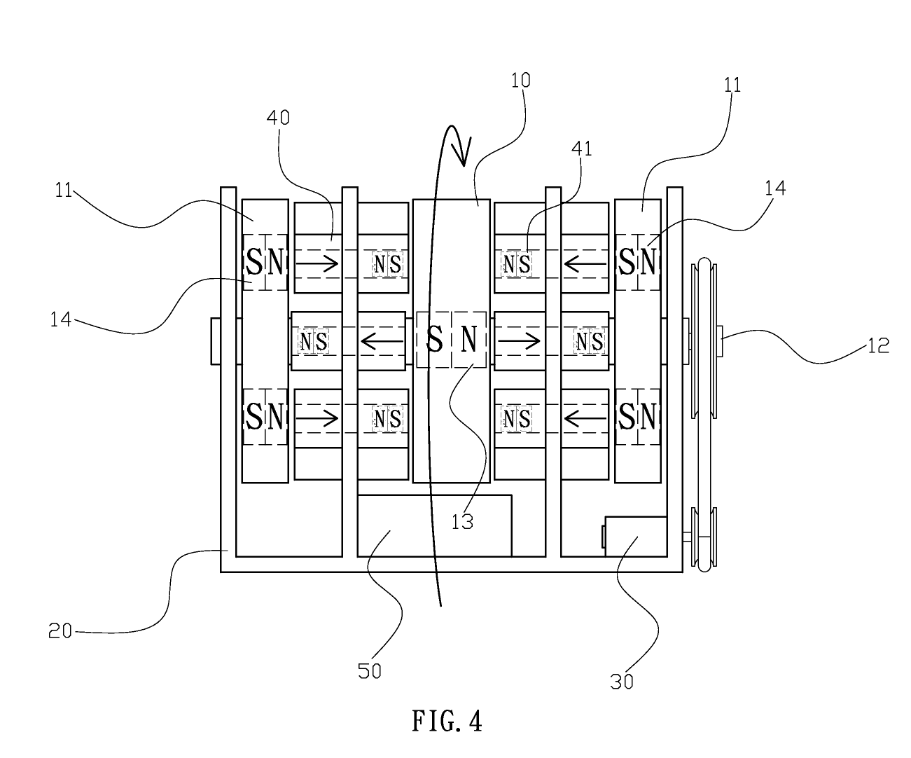

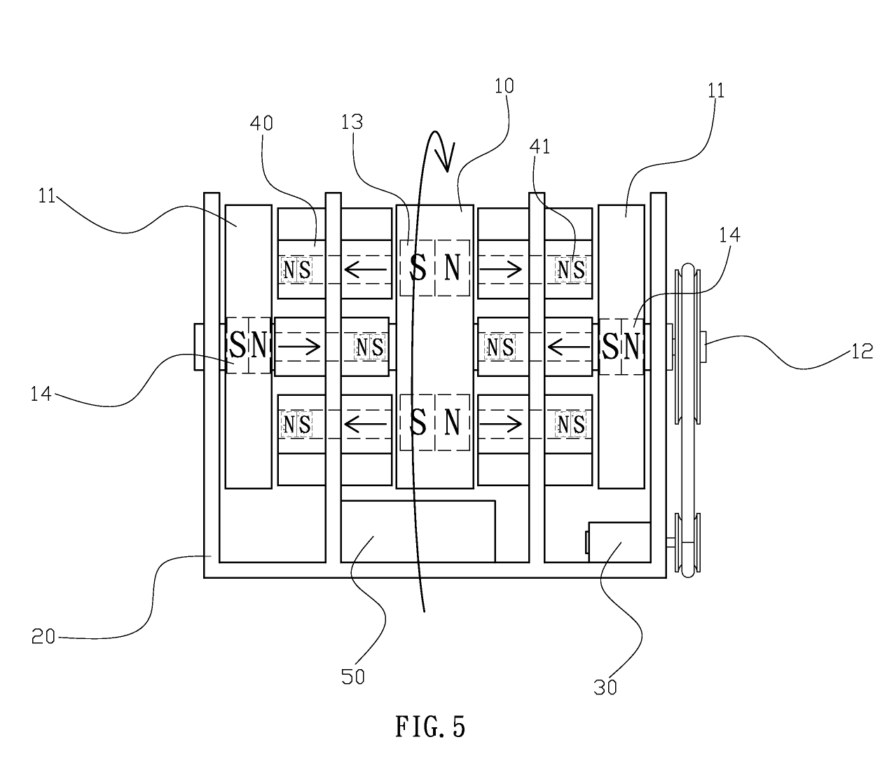

For actual use, please refer to FIG. 3, FIG. 4 and FIG. 5. The battery 50 provides electricity to the power unit 30 to drive the first and second rotation disks 10, 11 to rotate such that the permanent magnets 13 and the auxiliary magnets 14 on the first and second rotation disks 10, 11 are simultaneously driven and alternatively make their N poles and S poles to face the force magnets 41 in each sleeve tube 40. Meanwhile, the force magnets 41 consequently move back and forth in their sleeve tubes 40 because when the S pole of an auxiliary magnet 14 faces the S pole of the force magnet 41, the force magnet 41 is pushed away from the auxiliary magnet 14 and moves towards the first rotation disk 10; and when the first and second rotation disks 10, 11 rotate through a certain angle, the N pole of the force magnet 41 then faces the N pole of the permanent magnet 13, and the force magnet 41 is pushed back towards the second rotation disk 11. Furthermore, the coil 42 generates corresponding magnetic lines of force cutting to induct current to provide electricity to the power unit 30 and even charge the battery 50 for future use.

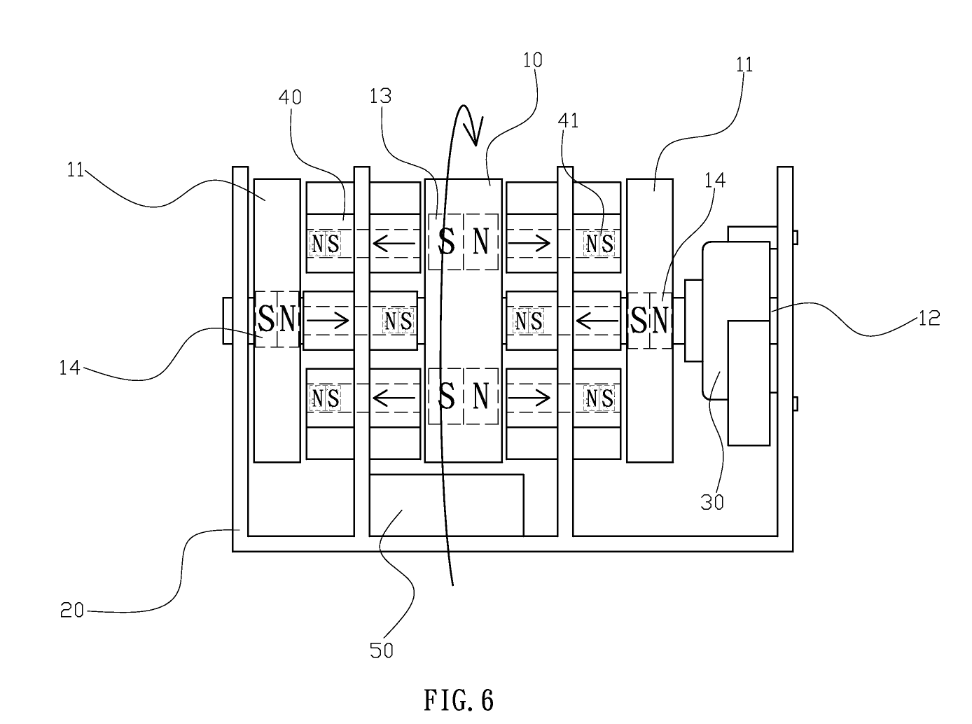

In addition, the power unit 30 includes a motor and matching belt, belt wheel or gear, as shown in FIG. 1 to FIG. 5, or only a motor as shown in FIG. 6. Each sleeve tube 40 further has a coating layer 43 covering around the coil 42 to provide insulation.

The electricity output by the electromotive inductive core is a direct current, but with an alternating and direct electric power switching device, it can be converted for application in: automobile use, household use, industrial use, or auxiliary electricity generating systems.

The above-mentioned electromotive inductive core has the following benefits: 1. the electromotive inductive core has more than one sleeve tube 40, and each sleeve tube 40 is wrapped with the coil 42 and has a slidable force magnet 41 such that each coil 42 and force magnet 41 are paired to work with each other. 2. The electricity output by the electromotive inductive core is direct current, but with an alternating and direct electric power switching device, it can be converted for applications in: automobile use, household use, industrial use, or auxiliary electricity generating systems for energy conservation purposes.

Although the present invention has been explained in relation to its preferred embodiment, it is to be understood that many other possible modifications and variations can be made without departing from the spirit and scope of the invention as hereinafter claimed.

What is claimed is:

1. An electromotive inductive core for a generator comprising: a first rotation disk and at least two second rotation disks, the first rotation disk sandwiched with a respective distance between the second rotation disks, a driving shaft passing through a central position of the first and second rotation disks and connected to a power unit to drive the first and second rotation disks to simultaneously rotate, a plurality of permanent magnets and auxiliary magnets disposed around each of the first and second rotation disks adjacent to an outer edge thereof, the permanent magnets and the auxiliary magnets being disposed on respective disks in an alternating manner and interleaved between adjacent disks with opposite poles facing each other; a plurality of sleeve tubes disposed adjacent to at least a side of each of the first rotation disk and the second rotation disk, each sleeve tube having a slidable force magnet and wrapped with a coil, ends of each coil electrically connected to a battery;
wherein the battery provides power to operate a power unit to drive the first and second rotation disks to rotate such that the permanent magnets and the auxiliary magnets on the first and second rotation disks simultaneously rotate and alternate N poles and S poles to face the force magnet in each sleeve tube; meanwhile, the force magnet is capable of moving along in the sleeve tube, which generates electricity to supply the power unit or charge the battery.

2. The electromotive inductive core as claimed in claim 1 further comprising a supporting frame, the driving shaft on the first and second rotation disks pivoted onto the supporting frame, and the sleeve tubes are fixed onto the supporting frame for positioning between the first and second rotation disks.

3. The electromotive inductive core as claimed in claim 1, wherein the power unit comprises a motor, a corresponding belt, and a transmission wheel.

4. The electromotive inductive core as claimed in claim 1, wherein the power unit comprises a motor and a gear.

5. The electromotive inductive core as claimed in claim 1, wherein the power unit is a motor.

6. The electromotive inductive core as claimed in claim 1, wherein coating layers cover the coils of the sleeve tubes that provide magnetic force insulation.

7. The electromotive inductive core as claimed in claim 1, wherein the
number of sleeve tubes, force magnets and coils can be varied.
